(19) United States
(12) Patent Application Publication
(10) Pub. No.: US 2023/0356601 A1
(43) Pub. Date: Nov. 9, 2023

(54) BRAKING CONTROL DEVICE

(71) Applicant: ADVICS CO., LTD., Kariya-shi, Aichi-ken (JP)

(72) Inventors: Yusaku YAMAMOTO, Kariya-shi, Aichi-ken (JP); Kazuaki YOSHIDA, Kariya-shi, Aichi-ken (JP)

(73) Assignee: ADVICS CO., LTD., Kariya-shi, Aichi-ken (JP)

(21) Appl. No.: 18/245,724

(22) PCT Filed: Sep. 30, 2021
(86) PCT No.: PCT/JP2021/036183

§ 371 Date: Mar. 17, 2023

(30) Foreign Application Priority Data
Sep. 30, 2020 (JP) 2020-166319

(51) Int. Cl. B60L 7/26; B60T 8/1755

(52) U.S. Cl. CPC B60L 7/26; B60T 8/1755; B60T 2270/604; B60L 2260/40

(57) ABSTRACT

A braking control device adjusts a regenerative braking force and a friction braking force applied to a vehicle. The braking control device includes a stopping distance acquisition unit that acquires a distance moved until the vehicle in travel stops, as a stopping distance. The braking control device includes a brake adjustment unit that starts replacement control to replace the regenerative braking force among braking forces, which are applied to the vehicle, with the friction braking force, when the stopping distance becomes smaller than a replacement determination value.

### TECHNICAL FIELD

The present disclosure relates to a braking control device for a vehicle.

### BACKGROUND ART

PTL 1 discloses a control device that performs control of a braking force when a vehicle stops. The control device specifies the time that control is performed, based on a vehicle speed of the vehicle during deceleration.

### CITATION LIST

### Patent Literature

PTL 1: JP2016-28913A

### SUMMARY

### Technical Problem

For example, a detection signal from a wheel speed sensor may be used to calculate a vehicle speed. The detection signal from the wheel speed sensor contains pulses generated at intervals according to a rotational speed of a wheel. The interval between the pulses contained in the detection signal increases immediately before the wheel stops rotating. When the interval between the pulses increases, the wheel may be determined to have stopped even immediately before the wheel stops rotating. In addition, a detection signal from a rotation angle sensor of an electric motor that is a power source of the vehicle may be used to calculate a vehicle speed. In this case, there are circumstances where it is difficult to detect the moment immediately before the wheel stops rotating, due to an influence of torsion of a shaft or the like on a transmission path from the power source to the wheel. Namely, when the detection signal from the wheel speed sensor or the detection signal from the rotation angle sensor of the electric motor is used to calculate a vehicle speed, it is difficult to detect the moment immediately before the wheel stops rotating. For this reason, when the vehicle travels at a low speed, a decrease in the detection accuracy of vehicle speed, such as the vehicle speed being calculated as “0” at the point when the actual vehicle speed is not “0”, occurs, which is a concern.

When the detection accuracy of vehicle speed decreases and the vehicle speed is calculated as a value different from that of the actual speed in such a manner, in the control device that performs control of the braking force based on the vehicle speed as disclosed in PTL 1, the time that control is started is earlier or later than an originally planned time, which is a problem. In the case where the braking force applied during braking is a regenerative braking force, when the time that control is started is delayed, the efficiency of recovering regenerative energy may decrease.

### Solution to Problem

In order to solve the foregoing problems, there is provided a braking control device that is applied to a brake device of a vehicle to adjust a regenerative braking force and a friction braking force applied to the vehicle, the breaking control device including: a stopping distance acquisition unit that acquires a distance moved until the vehicle in travel stops, as a stopping distance; and a brake adjustment unit that starts replacement control to replace the regenerative braking force among braking forces, which are applied to the vehicle, with the friction braking force when the stopping distance becomes smaller than a replacement control start threshold value.

In the above configuration, the replacement of the braking force is started based on the stopping distance. For this reason, even in a situation where the detection accuracy of vehicle speed decreases, a deviation between an intended time specified in the replacement control and an actual starting time of the replacement control is unlikely to occur. For example, the lower the vehicle speed is, the further the detection accuracy of vehicle speed decreases; however, according to the above configuration, it is possible to suppress the occurrence of a deviation between the times even when the vehicle speed is low, such as when the vehicle is about to stop.

### BRIEF DESCRIPTION OF DRAWINGS

FIG. 1 is a block diagram illustrating one embodiment of a braking control device applied to a brake device, and a vehicle including the same brake device.

FIG. 2 is a graph for describing a transition of the target value of a braking force in pre-stop braking control executed by the same braking control device when the vehicle stops.

FIG. 3 is a flowchart illustrating the flow of a processing when the same braking control device executes replacement control.

FIG. 4 is a flowchart illustrating the flow of a processing for the pre-stop braking control executed by the same braking control device.

FIG. 5 is a flowchart illustrating the flow of a ratio setting process executed by the same braking control device.

FIGS. 6A-6E are a timing chart illustrating a transition of the target value of a braking force controlled by the same braking control device when the vehicle stops.

FIGS. 7A-7E are a timing chart illustrating a transition of the target value of a braking force controlled by the same braking control device when the vehicle stops.

### DESCRIPTION OF EMBODIMENTS

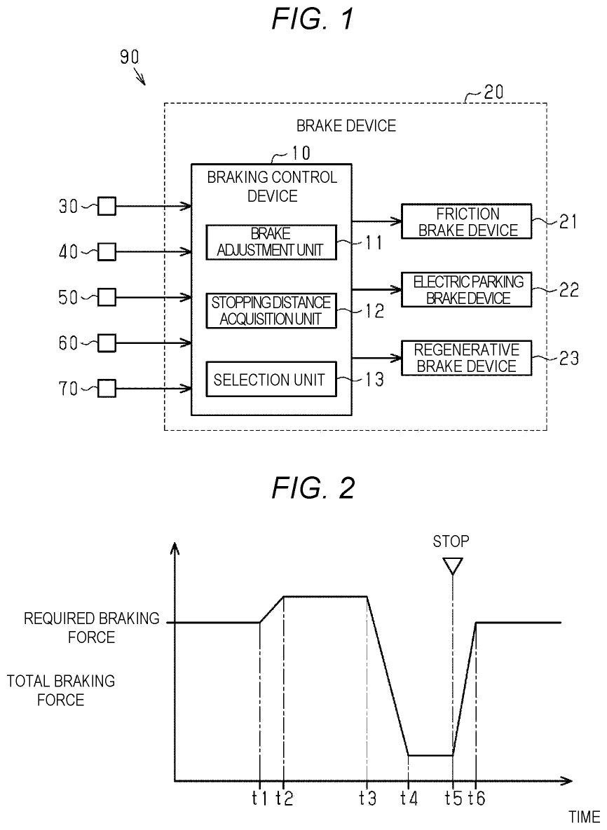

Hereinafter, one embodiment of a braking control device will be described with reference to FIGS. 1 to 7.

A brake device 20 illustrated in FIG. 1 includes a friction brake device 21 and a regenerative brake device 23. The brake device 20 may include an electric parking brake device 22. The brake device 20 includes a braking control device 10 that controls the friction brake device 21, the regenerative brake device 23, and the electric parking brake device 22. The brake device 20 is installed on a vehicle 90.

The friction brake device 21 can apply a braking force according to a force that presses a friction material, to a wheel by pressing the friction material against a rotating body that integrally rotates with the wheel of the vehicle 90. One example of the friction brake device 21 is a brake device that can apply a braking force to a wheel by pressing a friction material against a rotating body according to hydraulic pressure generated by a hydraulic pressure generating device. The braking force applied to the wheel by the operation of the friction brake device 21 is referred to as a friction braking force. The friction brake device 21 can individually adjust the friction braking force applied to a front wheel and the friction braking force applied to a rear wheel. The friction brake device 21 may be configured to be able to individually adjust the friction braking forces applied to the wheels.

The regenerative brake device 23 is formed of a front wheel motor-generator and a rear wheel motor-generator. The vehicle 90 includes each motor-generator, a power control unit, and a battery. Each motor-generator is connected to the battery through the power control unit. The power control unit includes an inverter and a converter.

A braking force according to the amount of electricity generated per hour by a motor-generator is applied to a wheel by causing the motor-generator to function as a generator, and the generated electricity is stored in the battery. A braking force can be applied to the front wheel by causing the front wheel motor-generator to function as a generator, and a braking force can be applied to the rear wheel by causing the rear wheel motor-generator to function as a generator. The braking force applied by the regenerative brake device 23 is referred to as a regenerative braking force. Incidentally, a driving force can be transmitted to a wheel from a motor-generator by causing the motor-generator to function as an electric motor. In addition, when an in-wheel motor is provided on each wheel of the vehicle 90, the regenerative brake device 23 is formed of the in-wheel motor. In such a manner, the regenerative brake device 23 may be able to individually adjust the regenerative braking forces applied to the wheels.

The brake device 20 can perform coordinated control of the friction braking force and the regenerative braking force. Hereinafter, a combination of the friction braking force applied to the vehicle 90 by the brake device 20 and the regenerative braking force applied to the vehicle 90 by the brake device 20 may be referred to as a total braking force applied to the vehicle 90.

The electric parking brake device 22 is provided on the rear wheel of the wheels of the vehicle 90. The electric parking brake device 22 may be provided on the front wheel. The electric parking brake device 22 can apply a braking force to hold the state where the vehicle 90 has stopped when the vehicle 90 is stopped. The electric parking brake device 22 includes an electric motor that is a drive source. The electric parking brake device 22 changes an interval between a rotating body and a friction material in conjunction with the rotation of the electric motor. The rotating body and the friction material forming the electric parking brake device 22 are the rotating body and the friction material provided in the friction brake device 21. Namely, the electric parking brake device 22 is a brake device that applies a braking force by pressing the friction material against the rotating body via driving of the electric motor. The braking force applied to a wheel by the operation of the electric parking brake device 22 is a friction braking force.

The vehicle 90 on which the brake device 20 is installed includes various sensors that detect states of the vehicle 90. Detection signals from the various sensors are input to the braking control device 10. The vehicle 90 includes a mode selection member 50. The mode selection member 50 is connected to the braking control device 10. The vehicle 90 includes a measurement device 60. The vehicle 90 may include an assist control device 70. The measurement device 60 and the assist control device 70 can transmit and receive information to and from the braking control device 10.

In addition, the vehicle 90 may include another control device capable of transmitting and receiving to and from the braking control device 10, in addition to the assist control device 70. Examples of the another control device include a drive control device that controls a power source of the vehicle 90, a steering control device that controls the steering of the vehicle 90, and the like.

As illustrated in FIG. 1, the vehicle 90 includes an operation amount sensor 30 as one of the various sensors. The operation amount sensor 30 detects an operation amount of a braking operation member operated by a driver of the vehicle 90. The braking operation member is operated by the driver when braking the vehicle 90. One example of the braking operation member is a brake pedal. In this case, the operation amount sensor 30 is a pedal force sensor that detects a force with which the brake pedal is depressed.

The vehicle 90 includes a wheel speed sensor 40 as one of the various sensors. The wheel speed sensor 40 is attached to each corresponding wheel of the vehicle 90. A speed of each wheel of the vehicle 90 is calculated based on a detection signal from the wheel speed sensor 40. A vehicle speed that is a speed of the vehicle 90 is calculated based on the speed of each wheel.

One example of the mode selection member 50 is a push button switch. The mode selection member 50 may be a toggle switch or the like. The mode selection member 50 is disposed in the interior of the vehicle 90. The mode selection member 50 can be operated by the driver of the vehicle 90. When the mode selection member 50 is operated by the driver, the braking control device 10 switches braking control of the vehicle 90 to a fuel efficiency priority mode or to a comfort priority mode. Namely, the driver can select the fuel efficiency priority mode or the comfort priority mode.

The fuel efficiency priority mode that can be selected by the operation of the mode selection member 50 is a mode in which the total braking force applied to the vehicle 90 is adjusted to store a large amount of electricity generated by the application of the regenerative braking force when the vehicle 90 is braked. The comfort priority mode that can be selected by the operation of the mode selection member 50 is a mode in which the total braking force applied to the vehicle 90 is adjusted to reduce shaking of a vehicle body, namely, a pitching motion when the vehicle 90 is braked.

The measurement device 60 has the function of acquiring information about surroundings of the vehicle 90. The measurement device 60 includes a camera that captures images of the surroundings of the vehicle 90. The measurement device 60 includes an information processing unit that processes the images captured by the camera. For example, the measurement device 60 can measure a distance from the vehicle 90 as a reference point to a specific position around the vehicle 90 by analyzing the captured images via the information processing unit. The measurement device 60 outputs information obtained by the information processing unit, to the braking control device 10. The measurement device 60 may include a millimeter wave radar, a LIDAR, a sonar, or the like as a device other than the camera. The measurement device 60 may acquire information about the surroundings of the vehicle 90 via a combination of a plurality of devices.

The measurement device 60 may include a receiving device that receives information transmitted from GPS satellites. The measurement device 60 can also identify a current position of the vehicle 90 based on the information received from the GPS satellites.

The assist control device 70 has the function of automatically driving the vehicle 90. The information acquired by the measurement device 60 is also input to the assist control device 70. The assist control device 70 sets a target position of the vehicle 90 and a travel route to the target position. The assist control device 70 sets the target position and the travel route using the information obtained by the measurement device 60. The assist control device 70 can cause the vehicle 90 to automatically travel based on the target position and the travel route, through instructions to the braking control device 10, the drive control device, and the steering control device. Incidentally, the information acquired by the measurement device 60 may be input to the braking control device 10 through the assist control device 70.

The braking control device 10, the information processing unit provided in the measurement device 60, the assist control device 70, and other control devices provided in the vehicle 90 may have any one of the following configurations (a) to (c). (a) One or more processors that execute various processes according to a computer program are provided. The processor includes a CPU and memories such as a RAM and a ROM. The memories store program codes or commands configured to cause the CPU to execute processes. The memories, namely, computer-readable media include any available media that can be accessed by a general-purpose or dedicated computer. (b) One or more dedicated hardware circuits that execute various processes are provided. The dedicated hardware circuit is, for example, an application specific integrated circuit (ASIC) or a field programmable gate array (FPGA), or the like. (c) A processor that executes some of various processes according to a computer program and a dedicated hardware circuit that executes the remaining of the various processes are provided.

The braking control device 10 includes a brake adjustment unit 11, a stopping distance acquisition unit 12, and a selection unit 13 as functional units.

The selection unit 13 selects the fuel efficiency priority mode or the comfort priority mode according to a state of the mode selection member 50. The fuel efficiency priority mode is one control mode among a plurality of control modes for the vehicle. The comfort priority mode is one control mode among the plurality of control modes for the vehicle. The selection unit 13 selects any one control mode among the plurality of control modes for the vehicle. Namely, when the fuel efficiency priority mode is viewed as a “first control mode”, the comfort priority mode corresponds to a “second control mode”.

The stopping distance acquisition unit 12 acquires a distance moved until the vehicle 90 in travel stops, as a stopping distance DIS. The minimum value of the stopping distance DIS is “0”. For example, the stopping distance acquisition unit 12 starts to acquire the stopping distance DIS when braking of the vehicle 90 is started. The stopping distance acquisition unit 12 repeatedly acquires the stopping distance DIS at predetermined intervals during braking of the vehicle 90, and updates a previously acquired value with a currently acquired value.

One example of a configuration in which the stopping distance acquisition unit 12 acquires the stopping distance DIS will be described. When a travel route until the vehicle 90 stops is set and the traveling of the vehicle 90 is controlled by the assist control device 70, a position where the vehicle 90 stops corresponds to a target position. In this case, the stopping distance acquisition unit 12 can acquire a distance from a current position of the vehicle 90 to the target position as the stopping distance DIS.

As another example, the stopping distance acquisition unit 12 can also acquire a distance to a stopping position as the stopping distance DIS by estimating a position where the vehicle 90 stops, as the stopping position, and by measuring the distance via the measurement device 60. The position where the vehicle 90 stops can be estimated from vehicle speed, deceleration, and the like. In addition, the stopping distance acquisition unit 12 can also acquire a distance from a current position of the vehicle 90 to a stopping position as the stopping distance DIS by estimating a position where the vehicle 90 stops, as the stopping position, and by calculating the distance. Alternatively, the stopping distance acquisition unit 12 can also acquire the stopping distance DIS by storing the value of a calculated distance to a stopping position as an initial stopping distance, and by subtracting a distance by which the vehicle 90 has actually traveled from the point when the initial stopping position is calculated, from the initial stopping position.

The brake adjustment unit 11 has the function of controlling the friction brake device 21, the regenerative brake device 23, and the electric parking brake device 22. The brake adjustment unit 11 calculates target values for control of the friction brake device 21, the regenerative brake device 23, and the electric parking brake device 22. The brake adjustment unit 11 calculates a required braking force as the target value of a total braking force based on an operation amount of the braking operation member. When automatic driving is executed by the assist control device 70, the brake adjustment unit 11 sets a value based on a command value from the assist control device 70, as a required braking force. The brake adjustment unit 11 sets a ratio of the regenerative braking force to the total braking force, and adjusts the friction braking force and the regenerative braking force applied to each wheel. The ratio of the regenerative braking force to the total braking force may be referred to as a regenerative ratio. In addition, the brake adjustment unit 11 also sets a ratio of a front wheel friction braking force, which is applied to the front wheel, to the friction braking force. In addition, the brake adjustment unit 11 also sets a ratio of a front wheel regenerative braking force, which is applied to the front wheel, to the regenerative braking force. The brake adjustment unit 11 can individually adjust the braking forces applied to the wheels by controlling the friction brake device 21, the regenerative brake device 23, and the electric parking brake device 22 based on the calculated target values.

The brake adjustment unit 11 executes pre-stop braking control during braking of the vehicle 90. When the pre-stop braking control is executed, the braking force applied to the vehicle 90 is reduced immediately before the vehicle 90 stops. The pre-stop braking control is control that adjusts the braking force applied to the vehicle to suppress vehicle body behavior of the vehicle. The amount of change in forward and backward acceleration when the vehicle 90 stops is suppressed to a low level by the pre-stop braking control. In the pre-stop braking control, the brake adjustment unit 11 adjusts the total braking force applied to the vehicle 90 according to a braking force profile.

In the pre-stop braking control, the brake adjustment unit 11 adjusts the braking force by holding a regenerative ratio at the starting point of the pre-stop braking control. For example, when the required braking force is satisfied only by the regenerative braking force at the starting point of the pre-stop braking control, the braking force reduced by the pre-stop braking control is the regenerative braking force. In addition, when the required braking force is satisfied only by the friction braking force at the starting point of the pre-stop braking control, the braking force reduced by the pre-stop braking control is the friction braking force.

In the pre-stop braking control, the brake adjustment unit 11 can also adjust the braking force by changing the regenerative ratio at the starting point of the pre-stop braking control. For example, when the regenerative braking force and the friction braking force are applied at the starting point of the pre-stop braking control, the amount of reduction in the regenerative braking force may be larger than the amount of reduction in the friction braking force with respect to the braking force reduced by the pre-stop braking control.

An overview of the braking force profile in the pre-stop braking control will be described with reference to FIG. 2. FIG. 2 illustrates the braking force profile as a transition of the target value of the total braking force. In the example illustrated in FIG. 2, time t5 is when the vehicle 90 is stopped. Incidentally, the state where the wheels of the vehicle 90 have stopped rotating is referred to as the vehicle 90 being stopped.

In the braking force profile, a period from time t3 to time t4 before time t5 is set as a period in which the total braking force is gradually reduced. In the braking force profile, a period from time t4 to time t5 is set as a period in which the total braking force is maintained constant. Hereinafter, a period in which the braking force applied to the vehicle 90 immediately before the vehicle 90 stops is maintained at a low value, such as the period from time t4 to time t5, may be referred to a pre-stop holding period. Incidentally, the amount of reduction in the total braking force per hour and the length of the period in which the total braking force is maintained constant are adjusted according to vehicle speed, deceleration, a distance to the position where the vehicle 90 is stopped, and the like.

In addition, as illustrated in FIG. 2, in the profile set by the brake adjustment unit 11, the total braking force is increased after time t5. This is to suppress a movement of the vehicle 90 after stopping and to hold the state where the vehicle 90 has stopped. In the braking force profile, a period from time t5 to time t6 is set as a period in which the total braking force is increased to the required braking force. After time t6 that the total braking force reaches the required braking force, the total braking force is maintained at the required braking force. Incidentally, it is not essential that the total braking force after increase coincides with the required braking force.

By the way, when a period in which the total braking force during braking is reduced below the required braking force is provided, the braking distance of the vehicle 90 may increase. Therefore, in the pre-stop braking control, the brake adjustment unit 11 reduces the difference in braking distance between the case of reducing the total braking force immediately before the vehicle 90 stops and in the case of not reducing the total braking force.

Specifically, the brake adjustment unit 11 temporarily increases the total braking force before starting to reduce the total braking force. In the profile set by the brake adjustment unit 11, a period from time t1 to time t2 before time t3 is set as a period in which the total braking force is gradually increased. In the braking force profile, a period from time t2 to time t3 is set as a period in which the total braking force is maintained constant. The brake adjustment unit 11 calculates the amount of increase in the total braking force and a period in which the total braking force is increased, in consideration of that the braking distance is shortened as the total braking force is increased above the required braking force, and reflects the amount of increase and the period in the setting of the braking force profile.

In the present embodiment, the brake adjustment unit 11 controls when to start to change the total braking force during execution of the pre-stop braking control, based on the stopping distance DIS. The brake adjustment unit 11 sets a value of the stopping distance DIS corresponding to time t1 as an increase determination value th1. The increase determination value th1 is a value for determining when to start to increase the total braking force. The brake adjustment unit 11 sets a value of the stopping distance DIS corresponding to time t3 as a reduction determination value th2. The reduction determination value th2 is a value for determining when to start to reduce the total braking force. The brake adjustment unit 11 sets a value of the stopping distance DIS corresponding to time t4 as a maintenance determination value th3. The maintenance determination value th3 is a value for determining when to start to maintain the total braking force. In other words, the maintenance determination value th3 is a value for determining when to end the reduction in the total braking force.

As described above, the brake adjustment unit 11 sets the determination values th1 to th3 based on the braking force profile, when executing the pre-stop braking control. In addition, during execution of the pre-stop braking control, the brake adjustment unit 11 adjusts the amount of control of the friction brake device 21 and the amount of control of the regenerative brake device 23 such that the total braking force is changed according to the braking force profile. The braking force profile illustrating a transition of the target value of the total braking force has been provided as an example of the profile for controlling the braking force in the pre-stop braking control; however, the braking force can also be controlled according to a deceleration profile illustrating a transition of the target value of deceleration, so as to realize the deceleration.

The brake adjustment unit 11 executes replacement control during braking of the vehicle 90. In the replacement control, the brake adjustment unit 11 replaces the regenerative braking force applied to the wheel, with the friction braking force. Specifically, the brake adjustment unit 11 controls the regenerative brake device 23 to reduce the regenerative braking force, and controls the friction brake device 21 to increase the friction braking force such that the total braking force is not changed due to the amount of reduction in the regenerative braking force. Namely, it can be said that the replacement control is control that changes the ratio of the regenerative braking force to the required braking force. The replacement control executed after the reduction in the braking force is started by the pre-stop braking control is referred to as a first replacement control. The replacement control executed before the reduction in the braking force is started by the pre-stop braking control is referred to as a second replacement control. In addition, the replacement control performed when the pre-stop braking control is not executed is referred to as a third replacement control.

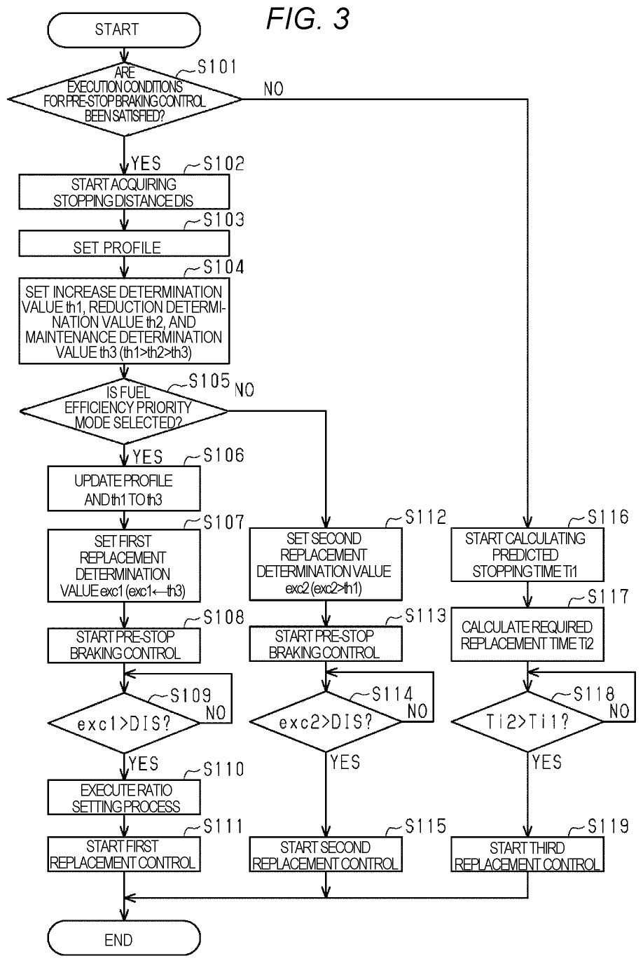

A flow when the pre-stop braking control and the replacement control are executed by the brake adjustment unit 11 will be described with reference to FIGS. 3 to 5. FIG. 3 illustrates the flow of a processing executed by the brake adjustment unit 11. This processing routine is started when the vehicle speed becomes lower than a specified start determination value after the application of the braking force to the vehicle 90 is started.

When this processing routine is started, first, in step S101, the brake adjustment unit 11 determines whether execution conditions for the pre-stop braking control are satisfied. One example of the execution conditions will be described. Here, in the case where the target value of deceleration when the vehicle speed becomes lower than the specified start determination value is less than a predetermined value, the brake adjustment unit 11 determines that the execution conditions are satisfied. On the other hand, in the case where the target value of deceleration when the vehicle speed becomes lower than the specified start determination value is the predetermined value or more, the brake adjustment unit 11 determines that the execution conditions are not satisfied. Namely, the execution conditions are not satisfied in the case where the target value of deceleration when the vehicle speed has decreased due to braking is large.

When the execution conditions for the pre-stop braking control are satisfied (S101: YES), the brake adjustment unit 11 proceeds with the process to step S102. In step S102, the brake adjustment unit 11 starts to acquire the stopping distance DIS. The brake adjustment unit 11 acquires the stopping distance DIS from the stopping distance acquisition unit 12. The brake adjustment unit 11 repeatedly acquires the stopping distance DIS at predetermined intervals, and updates a previously acquired value with a currently acquired value. The brake adjustment unit 11 repeatedly acquires the stopping distance DIS until the vehicle 90 stops. When the brake adjustment unit 11 starts to acquire the stopping distance DIS, the brake adjustment unit 11 proceeds with the process to step S103.

In step S103, the brake adjustment unit 11 sets a braking force profile in the pre-stop braking control. The brake adjustment unit 11 sets the braking force profile based on the value of the stopping distance DIS acquired at this point. When the brake adjustment unit 11 sets the braking force profile, the brake adjustment unit 11 proceeds with the process to step S104.

In step S104, the brake adjustment unit 11 sets the increase determination value th1, the reduction determination value th2, and the maintenance determination value th3 based on the braking force profile set in the process of step S103. When the brake adjustment unit 11 sets the determination values th1 to th3, the brake adjustment unit 11 proceeds with the process to step S105.

In step S105, the brake adjustment unit 11 determines whether the fuel efficiency priority mode is selected. When the fuel efficiency priority mode is selected (S105: YES), the brake adjustment unit 11 proceeds with the process to step S106.

In step S106, the brake adjustment unit 11 updates the braking force profile set in step S103. The brake adjustment unit 11 sets the braking force profile suitable for control of the braking force according to the fuel efficiency priority mode. Specifically, the braking force profile that ensures the length of the pre-stop holding period is set such that replacement from the regenerative braking force to the friction braking force by the execution of the replacement control can be completed in the pre-stop holding period.

When the brake adjustment unit 11 updates the braking force profile, the brake adjustment unit 11 updates the increase determination value th1, the reduction determination value th2, and the maintenance determination value th3 based on a new braking force profile. Thereafter, the brake adjustment unit 11 proceeds with the process to step S107. Incidentally, if the length of the pre-stop holding period can be ensured by the braking force profile set in step S103, the update of the braking force profile and the update of the determination values th1 to th3 may be omitted.

In step S107, the brake adjustment unit 11 sets a first replacement determination value exc1. The first replacement determination value exc1 is a value set to determine a starting time of the first replacement control. The first replacement determination value exc1 is compared to the stopping distance DIS as will be described later. In other words, the first replacement determination value exc1 is set as a threshold value for starting the first replacement control. The first replacement determination value exc1 corresponds to a replacement control start threshold value. When the fuel efficiency priority mode is set as the first control mode, the first replacement determination value exc1 corresponds to a first replacement control start threshold value. The brake adjustment unit 11 sets the first replacement determination value exc1 to a value equal to the maintenance determination value th3 set in the process of step S106. Thereafter, the brake adjustment unit 11 proceeds with the process to step S108.

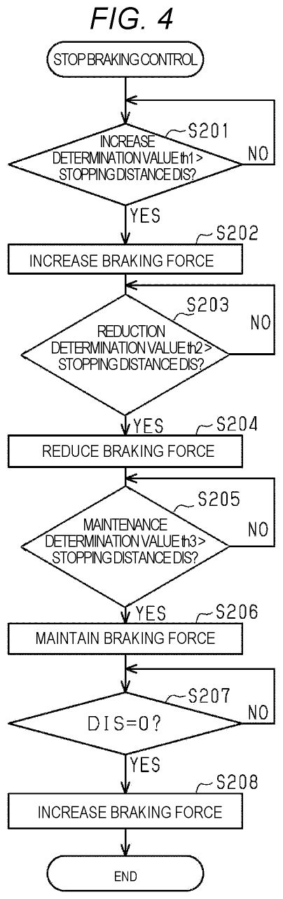

In step S108, the brake adjustment unit 11 starts the pre-stop braking control. When the brake adjustment unit 11 starts the pre-stop braking control in the process of step S108, the brake adjustment unit 11 proceeds with the process to step S109. The pre-stop braking control executed in the process of step S108 is executed in parallel to processes after step S109. Here, the pre-stop braking control will be described with reference to FIG. 4.

FIG. 4 illustrates the flow of the processing of the pre-stop braking control executed by the brake adjustment unit 11. The execution of this processing routine is started in the processing illustrated in FIG. 3. When this processing routine is started, first, in step S201, the brake adjustment unit 11 determines whether the stopping distance DIS is smaller than the increase determination value th1. When the stopping distance DIS is smaller than the increase determination value th1 (step S201: YES), the brake adjustment unit 11 proceeds with the process to step S202. On the other hand, when the stopping distance DIS is the increase determination value th1 or more (S201: NO), the brake adjustment unit 11 again determines whether the stopping distance DIS is smaller than the increase determination value th1. Namely, the brake adjustment unit 11 repeatedly executes the process of step S201 until the stopping distance DIS becomes smaller than the increase determination value th1.

In step S202, the brake adjustment unit 11 increases the total braking force above the required braking force according to the braking force profile set in advance. Thereafter, the brake adjustment unit 11 proceeds with the process to step S203.

In step S203, the brake adjustment unit 11 determines whether the stopping distance DIS is smaller than the reduction determination value th2. When the stopping distance DIS is smaller than the reduction determination value th2 (step S203: YES), the brake adjustment unit 11 proceeds with the process to step S204. On the other hand, when the stopping distance DIS is the reduction determination value th2 or more (S203: NO), the brake adjustment unit 11 again determines whether the stopping distance DIS is smaller than the reduction determination value th2. Namely, the brake adjustment unit 11 repeatedly executes the process of step S203 until the stopping distance DIS becomes smaller than the reduction determination value th2.

In step S204, the brake adjustment unit 11 reduces the total braking force according to the braking force profile set in advance. Thereafter, the brake adjustment unit 11 proceeds with the process to step S205.

In step S205, the brake adjustment unit 11 determines whether the stopping distance DIS is smaller than the maintenance determination value th3. When the stopping distance DIS is smaller than the maintenance determination value th3 (step S205: YES), the brake adjustment unit 11 proceeds with the process to step S206. On the other hand, when the stopping distance DIS is the maintenance determination value th3 or more (S205: NO), the brake adjustment unit 11 again determines whether the stopping distance DIS is smaller than the maintenance determination value th3. Namely, the brake adjustment unit 11 repeatedly executes the process of step S205 until the stopping distance DIS becomes smaller than the maintenance determination value th3.

In step S206, the brake adjustment unit 11 maintains the total braking force according to the braking force profile set in advance. Thereafter, the brake adjustment unit 11 proceeds with the process to step S207.

In step S207, the brake adjustment unit 11 determines whether the stopping distance DIS is “0”. When the stopping distance DIS is “0” (step S207: YES), the brake adjustment unit 11 proceeds with the process to step S208. On the other hand, when the stopping distance DIS has not reached “0” (S207: NO), the brake adjustment unit 11 again determines whether the stopping distance DIS is “0”. Namely, the brake adjustment unit 11 repeatedly executes the process of step S207 until the stopping distance DIS becomes “0”. In step S208, the brake adjustment unit 11 increases the total braking force according to the braking force profile set in advance. Thereafter, the brake adjustment unit 11 ends this processing routine.

Returning to FIG. 3, in step S109, the brake adjustment unit 11 determines whether the stopping distance DIS is smaller than the first replacement determination value exc1. When the stopping distance DIS is smaller than the first replacement determination value exc1 (step S109: YES), the brake adjustment unit 11 proceeds with the process to step S110. On the other hand, when the stopping distance DIS is the first replacement determination value exc1 or more (S109: NO), the brake adjustment unit 11 again determines whether the stopping distance DIS is smaller than the first replacement determination value exc1. Namely, the brake adjustment unit 11 repeatedly executes the process of step S109 until the stopping distance DIS becomes smaller than the first replacement determination value exc1.

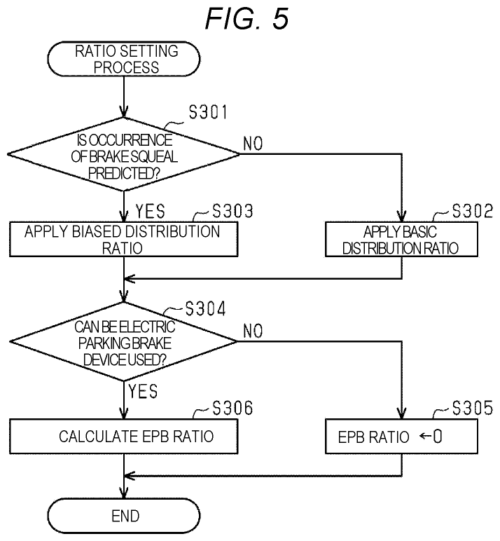

In step S110, the brake adjustment unit 11 executes a ratio setting process. The ratio setting process is a process of setting a friction braking force applied to the wheel as a result of execution of the first replacement control. The ratio setting process will be described with reference to FIG. 5.

FIG. 5 illustrates a processing routine of the ratio setting process executed by the brake adjustment unit 11. This processing routine is executed by the process of step S110 illustrated in FIG. 3. When this processing routine is started, first, in step S301, the brake adjustment unit 11 determines whether an occurrence of brake squeal is predicted. The brake squeal is abnormal sound generated by contact between the friction material and the rotating body of the friction brake device 21 For example, when the state where the friction braking force applied to the wheel is smaller than a predetermined threshold value continues for a specified period or more, an occurrence of brake squeal can be predicted. In this case, the predetermined threshold value is a value that is slightly larger than “0”.

When an occurrence of brake squeal is not predicted (S301: NO), the brake adjustment unit 11 proceeds with the process to step S302. In step S302, the brake adjustment unit 11 defines a ratio of the friction braking force applied to the front wheel to the friction braking force applied to the vehicle 90, as a distribution ratio, and applies a basic distribution ratio to the distribution ratio. The basic distribution ratio corresponds to a distribution ratio when braking that decelerates the vehicle 90 by applying only the friction braking force is started. Thereafter, the brake adjustment unit 11 proceeds with the process to step S304.

On the other hand, when an occurrence of brake squeal is predicted (S301: YES), the brake adjustment unit 11 proceeds with the process to step S303. In step S303, the brake adjustment unit 11 applies a biased distribution ratio to the distribution ratio. The biased distribution ratio is a distribution ratio which is adjusted such that the friction braking force applied to the front wheel or the friction braking force applied to the rear wheel is larger compared to when the friction braking force is applied according to the basic distribution ratio. One example of the biased distribution ratio is a distribution ratio in which all of the friction braking force applied to the vehicle 90 is taken up by the friction braking force applied to the front wheel. The biased distribution ratio may be a distribution ratio in which all of the friction braking force applied to the vehicle 90 is taken up by the friction braking force applied to the rear wheel. When the biased distribution ratio is applied to the distribution ratio, the brake adjustment unit 11 proceeds with the process to step S304.

In step S304, the brake adjustment unit 11 determines whether the electric parking brake device 22 as a device that generates a friction braking force after replacement is usable. For example, when the magnitude of the friction braking force after replacement can be realized by the operation of the electric parking brake device 22, it can be determined that the electric parking brake device 22 is usable. In addition, when a load applied to the electric parking brake device 22 based on the assumption that the friction braking force is applied by the electric parking brake device 22 is allowable, it can be determined that the electric parking brake device 22 is usable. The magnitude of the load can be estimated from the target value of the friction braking force after replacement, vehicle speed, and the like.

When the electric parking brake device 22 is not usable (S304: NO), the brake adjustment unit 11 proceeds with the process to step S305. In step S305, the brake adjustment unit 11 sets an EPB ratio to “0”. The EPB ratio indicates a ratio of the friction braking force applied by the operation of the electric parking brake device 22 to the friction braking force applied to the vehicle 90. Namely, the fact that the EPB ratio is “0” means that there is no friction braking force generated by the operation of the electric parking brake device 22. When the brake adjustment unit 11 sets the EPB ratio, the brake adjustment unit 11 ends this processing routine.

On the other hand, when the electric parking brake device 22 is usable (S304: YES), the brake adjustment unit 11 proceeds with the process to step S306. In step S306, the brake adjustment unit 11 calculates an EPB ratio. In step S306, the brake adjustment unit 11 calculates the EPB ratio as “100”. The fact that the EPB ratio is “100” means that there is no friction braking force generated by the operation of the friction brake device 21 and a friction braking force according to the target value of the friction braking force is applied to the wheel by the operation of the electric parking brake device 22. The brake adjustment unit 11 can also calculate the EPB ratio as a value between “0” to “100”. When the brake adjustment unit 11 sets the EPB ratio using the calculated value, the brake adjustment unit 11 ends this processing routine.

Returning to FIG. 3, when the ratio setting process executed in the process of step S110 ends, the brake adjustment unit 11 proceeds with the process to step S111.

In step S111, the brake adjustment unit 11 starts the first replacement control. The brake adjustment unit 11 controls the regenerative brake device 23, the friction brake device 21, and the electric parking brake device 22 to replace the regenerative braking force, which is applied to the wheel, with the friction braking force. At this time, the brake adjustment unit 11 controls the friction brake device 21 and the electric parking brake device 22 to apply the friction braking force according to the distribution ratio and the EPB ratio set by the ratio setting process. After the first replacement control is started, the brake adjustment unit 11 ends this processing routine.

When the fuel efficiency priority mode is not selected in the process of step S105, namely, when the comfort priority mode is selected (S105: NO), the brake adjustment unit 11 proceeds with the process to step S112.

In step S112, the brake adjustment unit 11 sets a second replacement determination value exc2. The second replacement determination value exc2 is a value set to determine a starting time of the second replacement control. The second replacement determination value exc2 is compared to the stopping distance DIS as will be described later. In other words, the second replacement determination value exc2 is set as a threshold value for starting the second replacement control. The second replacement determination value exc2 corresponds to a replacement control start threshold value. When the comfort priority mode is set as the second control mode, the second replacement determination value exc2 corresponds to a second replacement control start threshold value. The brake adjustment unit 11 sets the second replacement determination value exc2 to a value larger than the increase determination value th1 set in the process of step S104. For example, the brake adjustment unit 11 sets the second replacement determination value exc2 such that replacement is completed before the stopping distance DIS reaches the reduction determination value th2. When the brake adjustment unit 11 sets the second replacement determination value exc2, the brake adjustment unit 11 proceeds with the process to step S113.

In step S113, the brake adjustment unit 11 starts the pre-stop braking control. When the brake adjustment unit 11 starts the pre-stop braking control in the process of step S113, the brake adjustment unit 11 proceeds with the process to step S114. The pre-stop braking control executed in the process of step S113 is executed in parallel to processes after step S114. Since the flow of the processing of the pre-stop braking control which is started in step S113 has the same contents as those of the flow of the processing of the pre-stop braking control of which the execution is started in step S108, the description thereof will be omitted.

In step S114, the brake adjustment unit 11 determines whether the stopping distance DIS is smaller than the second replacement determination value exc2. When the stopping distance DIS is smaller than the second replacement determination value exc2 (step S114: YES), the brake adjustment unit 11 proceeds with the process to step S115. On the other hand, when the stopping distance DIS is the second replacement determination value exc2 or more (S114: NO), the brake adjustment unit 11 again determines whether the stopping distance DIS is smaller than the second replacement determination value exc2. Namely, the brake adjustment unit 11 repeatedly executes the process of step S114 until the stopping distance DIS becomes smaller than the second replacement determination value exc2.

In step S115, the brake adjustment unit 11 starts the second replacement control. The brake adjustment unit 11 controls the regenerative brake device 23 and the friction brake device 21 to replace the regenerative braking force, which is applied to the wheel, with the friction braking force. At this time, the brake adjustment unit 11 controls the friction brake device 21 to apply the friction braking force according to a distribution ratio different from the basic distribution ratio. After the second replacement control is started, the brake adjustment unit 11 ends this processing routine.

When the execution conditions for the pre-stop braking control are not satisfied in the process of step S101 (S101: NO), the brake adjustment unit 11 proceeds with the process to step S116.

In step S116, the brake adjustment unit 11 starts to calculate a predicted stopping time Ti1. The predicted stopping time Ti1 is a predicted value of the time required for the vehicle 90 to stop. When the brake adjustment unit 11 starts to calculate the predicted stopping time Ti1, the brake adjustment unit 11 repeatedly calculates the predicted stopping time Ti1 at predetermined intervals, and updates a previously calculated value with a currently calculated value. When the brake adjustment unit 11 starts to calculate the predicted stopping time Ti1, the brake adjustment unit 11 proceeds with the process to step S117.

In step S117, the brake adjustment unit 11 calculates a required replacement time Ti2. The required replacement time Ti2 is a predicted value of the time required for replacement from the regenerative braking force to the friction braking force to be completed. When the brake adjustment unit 11 calculates the required replacement time Ti2, the brake adjustment unit 11 proceeds with the process to step S118.

In step S118, the brake adjustment unit 11 determines whether the predicted stopping time Ti1 is smaller than the required replacement time Ti2. When the predicted stopping time Ti1 is smaller than the required replacement time Ti2 (step S118: YES), the brake adjustment unit 11 proceeds with the process to step S119. On the other hand, when the predicted stopping time Ti1 is the required replacement time Ti2 or more (S118: NO), the brake adjustment unit 11 again determines whether the predicted stopping time Ti1 is smaller than the required replacement time Ti2. Namely, the brake adjustment unit 11 repeatedly executes step S118 until the predicted stopping time Ti1 becomes smaller than the required replacement time Ti2.

In step S119, the brake adjustment unit 11 starts the third replacement control. The brake adjustment unit 11 controls the regenerative brake device 23 and the friction brake device 21 to replace the regenerative braking force, which is applied to the wheel, with the friction braking force. After the third replacement control is started, the brake adjustment unit 11 ends this processing routine.

Actions and effects of the present embodiment will be described.

First, the case where the pre-stop braking control and the replacement control are executed when the fuel efficiency priority mode is selected will be described as an example.

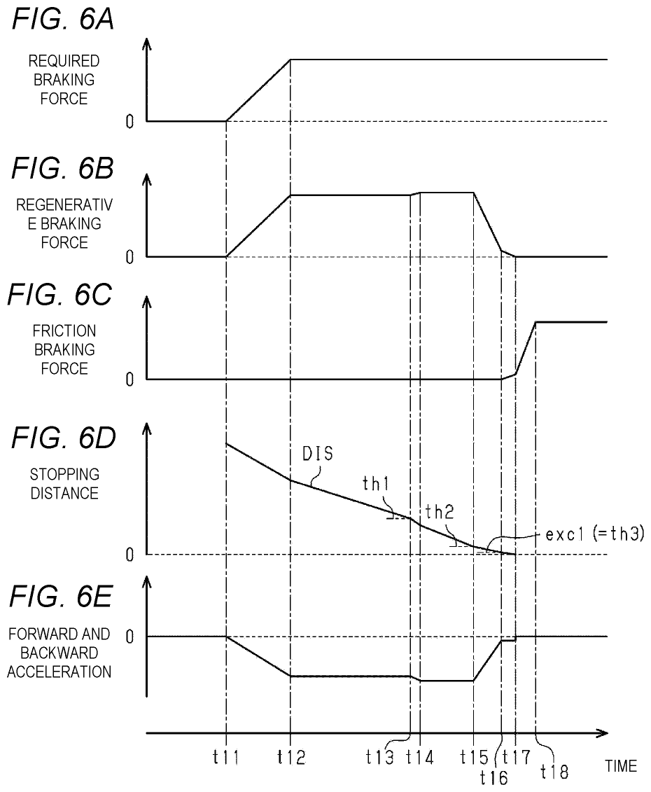

FIGS. 6A-6E illustrate a transition of the braking force applied to the vehicle 90 when the vehicle 90 stops due to braking. In the example illustrated in FIGS. 6A-6E, the execution conditions for the pre-stop braking control are satisfied. In the example illustrated, as illustrated in FIG. 6A, the required braking force is increased from time tn. The required braking force is maintained constant after time t12. Since the braking force is applied as the required braking force is increased, as illustrated in FIG. 6D, the stopping distance DIS is reduced with the elapse of time. In the example illustrated, as illustrated in FIG. 6D, the vehicle 90 has stopped at time t17 that the stopping distance DIS reaches “0”. In addition, in conjunction with the application of the braking force, as illustrated in FIG. 6E, the forward and backward acceleration has a negative value in a period from time t11 to time t17.

FIG. 6B illustrates the target value of the regenerative braking force. FIG. 6C illustrates the target value of the friction braking force. As illustrated in FIG. 6B, the brake device 20 is controlled such that the required braking force is satisfied by the regenerative braking force at the point when the application of the braking force is started.

When the stopping distance DIS is reduced by the application of the braking force and it is determined that the stopping distance DIS is smaller than the increase determination value th1 at time t13 (S201: YES), the increase in the braking force is started (S202). Here, the braking force is increased by holding the regenerative ratio before time t13. Namely, the regenerative braking force is increased. As a result, as illustrated in FIG. 6B, the regenerative braking force is gradually increased after time t13. The regenerative braking force is increased according to the braking force profile, and the regenerative braking force is maintained at a value larger than the required braking force after time t14.

When it is determined that the stopping distance DIS is smaller than the reduction determination value th2 at time t15 (S203: YES), the reduction in the braking force is started (S204). Here, the braking force is reduced also by holding the regenerative ratio. Namely, the regenerative braking force is reduced. As a result, as illustrated in FIG. 6B, the regenerative braking force is gradually reduced after time t15. The regenerative braking force is reduced to a value lower than the required braking force. Accordingly, as illustrated in FIG. 6E, the forward and backward acceleration of the vehicle 90 can brought close to “0” after time t15.

When it is determined that the stopping distance DIS is smaller than the maintenance determination value th3 at time t16 (S205: YES), the maintaining of the braking force is started (S206). At this time, in the example illustrated in FIGS. 6A-6E, the fuel efficiency priority mode is selected, so that the first replacement determination value exc1 is set as the same value as the maintenance determination value th3 (S107). Namely, at time t16, it is determined that the stopping distance DIS is smaller than the first replacement determination value exc1 (S109: YES), and the first replacement control is started (S111).

As a result, the total braking force is maintained and the regenerative braking force is replaced with the friction braking force. More specifically, as illustrated in FIG. 6B, the regenerative braking force is gradually reduced after time t16. Further, as illustrated in FIG. 6C, the friction braking force is gradually increased. Thus, the regenerative braking force is replaced with the friction braking force. Incidentally, at this time, when an occurrence of brake squeal is predicted (S301: YES), the biased distribution ratio is applied (S303). In this case, the front wheel friction braking force and the rear wheel friction braking force are applied based on the biased distribution ratio. Further, when the electric parking brake device 22 is usable (S304: YES), the EPB ratio is calculated (S306). In this case, the friction braking force is applied by the operation of the electric parking brake device 22.

When it is determined that the stopping distance DIS is “0” at time t17 (S207: YES), the increase in the braking force is started (S208). As a result, as illustrated in FIG. 6C, the friction braking force is gradually increased after time t17. The friction braking force is maintained at the required braking force after time t18.

In the braking control device 10, whether to start the first replacement control is determined based on the stopping distance DIS. For this reason, even in a situation where the detection accuracy of vehicle speed decreases, a deviation between an intended time specified in the replacement control and an actual starting time of the replacement control is unlikely to occur. For example, the lower the vehicle speed is, the further the detection accuracy of vehicle speed decreases; however, according to the braking control device 10, it is possible to suppress the occurrence of a deviation between the times even when the vehicle speed is low, such as when the vehicle 90 is about to stop.

In addition, when the detection accuracy of vehicle speed is low and it is difficult to detect whether the vehicle 90 is immediately before stopping, the accuracy of controlling the braking force when the vehicle 90 approaches a stopping position decreases, which is a concern. Particularly, when the regenerative braking force is applied by the regenerative brake device 23 immediately before the vehicle 90 stops, braking and regeneration are repeatedly performed until the vehicle 90 is stopped, which is a concern. Accordingly, energy consumption may increase. As a result, fuel efficiency may deteriorate, which is a concern.

According to the braking control device 10, it can be determined that the vehicle 90 is immediately before stopping, based on the stopping distance DIS. For this reason, it is possible to suppress unnecessary acceleration immediately before the vehicle 90 stops. In addition, it is possible to suppress an excessive increase in the braking force before the vehicle 90 reaches the stopping position. Accordingly, it is possible to suppress the increase in pitching motion of the vehicle 90 when the vehicle 90 stops.

When the fuel efficiency priority mode is selected, the time that replacement from the regenerative braking force to the friction braking force is started is after the time that the reduction in the braking force is started by the pre-stop braking control. For this reason, as in the period from time t11 to time t17 in the example illustrated in FIGS. 6A-6E, a long period in which the regenerative braking force is applied when the vehicle 90 is braked can be ensured. Accordingly, electricity stored in conjunction with the generation of the regenerative braking force can be increased.

In the braking control device 10, the first replacement determination value exc1 is set to the same value as the maintenance determination value th3. Namely, the first replacement determination value exc1 is set as a value smaller than the reduction determination value th2. For this reason, the time that the reduction in the braking force is started by the pre-stop braking control and the time that replacement is started are different from each other. Furthermore, replacement is performed in a period in which the reduction in the braking force by the pre-stop braking control is completed and the braking force is maintained. Compared to when replacement is performed while reducing the braking force, a difference between the target value of the braking force and an actual braking force is unlikely to occur. Accordingly, it is possible to suppress the decrease in the accuracy of controlling the braking force.

In addition, according to the braking control device 10, as a result of replacement from the regenerative braking force to the friction braking force, the friction braking force is applied before the vehicle 90 stops. If the application of the friction braking force is started from the point when the vehicle 90 has reached the stopping position, the braking force may be insufficient for the target value due to a response delay in hydraulic pressure or the like, and the vehicle 90 may move, which is a concern. On the other hand, according to the braking control device 10, the friction braking force is applied before the vehicle 90 reaches the stopping position, so that it is possible to suppress a movement of the vehicle 90 after the vehicle 90 has reached the stopping position.

In the braking control device 10, when the first replacement control is started, the regenerative braking force is in the state of being reduced by the pre-stop braking control. Namely, the magnitude of the regenerative braking force which is a replacement target is small. Accordingly, the gradient of change in the braking force when the regenerative braking force is replaced with the friction braking force can be reduced. Since there is no need to increase the amount of change in the braking force per hour, it is possible to suppress the decrease in the accuracy of controlling the braking force.

When the replacement control is performed after the braking force is reduced by the pre-stop braking control, the braking force which is a replacement target is reduced. When the magnitude of the friction braking force applied instead of the regenerative braking force is small, brake squeal may occur, which is a concern. In this regard, according to the braking control device 10, when an occurrence of brake squeal is predicted, the distribution ratio when the friction braking force is applied in the replacement control can be made different from the basic distribution ratio. Accordingly, the friction braking force can be applied while avoiding a braking force range in which brake squeal may occur.

In the braking control device 10, the friction braking force can be applied by the operation of the electric parking brake device 22 before the vehicle 90 stops. If the electric parking brake device 22 is operated after the vehicle 90 has stopped, the pressure with which the friction material is pressed against the rotating body may be lowered by the operation of the friction brake device 21. On the other hand, according to the braking control device 10, control that applies the friction braking force via the friction brake device 21 before the vehicle 90 stops and then that reduces the friction braking force after the vehicle 90 has stopped can be omitted. Accordingly, the number of times the friction brake device 21 is operated and the operation time of the friction brake device 21 can be reduced.

In the braking control device 10, the first replacement control can be executed immediately before the vehicle 90 stops. Namely, the time that the electric parking brake device 22 is operated in the first replacement control is immediately before the vehicle 90 stops, and at this time, the vehicle speed is low, and the forward and backward acceleration is close to “0”. For this reason, the electric parking brake device 22 is operated while the vehicle 90 is in travel, but it is possible to suppress the application of a load to the electric parking brake device 22.

Next, the case where the pre-stop braking control and the replacement control are executed when the comfort priority mode is selected will be described as an example.

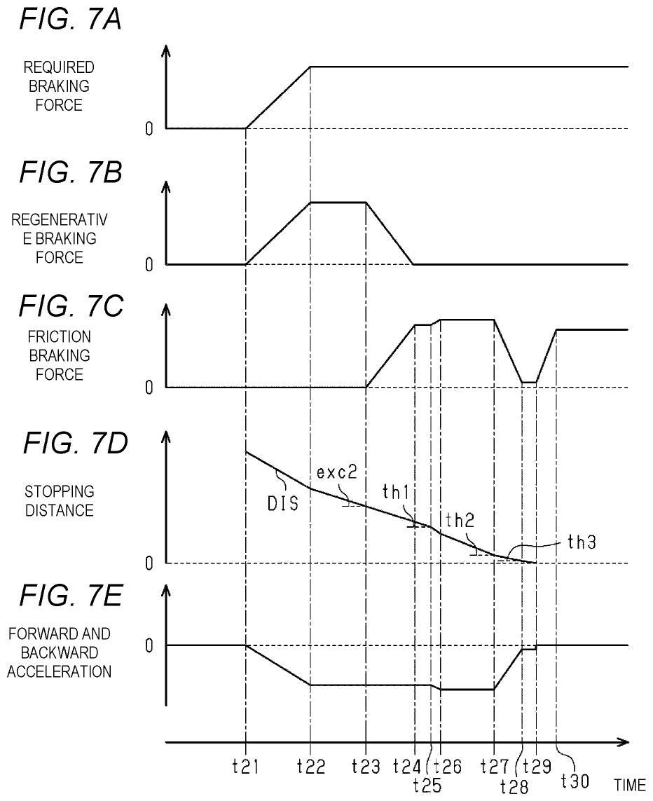

Similarly to the example illustrated in FIGS. 6A-6E, FIGS. 7A-7E illustrate a transition of the braking force applied to the vehicle 90 when the vehicle 90 is stopped by braking. As illustrated in FIG. 7A, the required braking force is increased from time t21. As illustrated in FIG. 7B, the regenerative braking force is applied as the required braking force is increased. The required braking force is maintained constant after time t22. The pre-stop braking control is executed, so that as illustrated in FIG. 7D, at time t25, it is determined that the stopping distance DIS is smaller than the increase determination value th1, and the increase in the braking force is started. At time t27, it is determined that the stopping distance DIS is smaller than the reduction determination value th2, and the reduction in the braking force is started. At time t28, it is determined that the stopping distance DIS is smaller than the maintenance determination value th3, and the maintaining of the braking force is started.

Differences between the example illustrated in FIGS. 7A-7E and the example illustrated in FIGS. 6A-6E will be described. In the example illustrated in FIGS. 7A-7E, the comfort priority mode is selected. For this reason, the time that the replacement control is started is different. Namely, a transition of the regenerative braking force illustrated in FIG. 7B and a transition of the friction braking force illustrated in FIG. 7C are different from those in the examples illustrated in FIGS. 6B and 6C.

In the example illustrated in FIGS. 7A-7E, the comfort priority mode is selected, so that the second replacement determination value exc2 is set as a value larger than the increase determination value th1 (S112). For this reason, in the example illustrated in FIGS. 7A-7E, at time t23 before time t25 that the braking force is increased by the pre-stop braking control, it is determined that the stopping distance DIS is smaller than the second replacement determination value exc2 (S114: YES), and the second replacement control is started (S115).

As a result, as illustrated in FIG. 7B, the regenerative braking force is gradually reduced after time t23. Further, as illustrated in FIG. 7C, the friction braking force is gradually increased. Thus, the regenerative braking force is replaced with the friction braking force. The replacement is completed at time t24.

When the distribution ratio is changed from the basic distribution ratio in the second replacement control, an anti-dive force and an anti-lift force acting on the vehicle 90 can be adjusted. The anti-dive force and the anti-lift force are forces that suppress a pitching motion of the vehicle 90. For example, the anti-lift force can be increased by increasing the friction braking force applied to the rear wheel. In addition, the anti-dive force can be increased by increasing the friction braking force applied to the front wheel.

At time t25 after time t24, the increase in the braking force is started by the pre-stop braking control. Here, the braking force is increased by holding the regenerative ratio before time t25. Since replacement from the regenerative braking force to the friction braking force is completed at time t24 before time t25, the friction braking force is increased. As a result, as illustrated in FIG. 7C, the friction braking force is gradually increased after time t25. The friction braking force is increased according to the braking force profile, and the friction braking force is maintained at a value larger than the required braking force after time t26.

At time t27, the reduction in the braking force is started by the pre-stop braking control. Here, the braking force is reduced also by holding the regenerative ratio. Namely, the friction braking force is reduced. As a result, as illustrated in FIG. 7C, the friction braking force is gradually reduced after time t27. The friction braking force is reduced to a value lower than the required braking force. Accordingly, as illustrated in FIG. 7E, the forward and backward acceleration of the vehicle 90 can brought close to “0” after time t27.

At time t28, the maintaining of the braking force is started by the pre-stop braking control. As a result, as illustrated in FIG. 7C, the friction braking force is maintained constant after time t28.

When it is determined that the stopping distance DIS is “0” at time t29 (S207: YES), the increase in the braking force is started (S208). As a result, as illustrated in FIG. 7C, the friction braking force is gradually increased after time t29. The friction braking force is maintained at the required braking force after time t30.

In the braking control device 10, even when the comfort priority mode is selected, similarly to the example illustrated in FIG. 6 in which the fuel efficiency priority mode is selected, the time that the reduction in the braking force is started by the pre-stop braking control and the time that the replacement control is started can be made different from each other.

Further, in the braking control device 10, when the comfort priority mode is selected, the braking force generated before the vehicle 90 stops is a friction braking force. The anti-lift force and the anti-dive force acting on the vehicle 90 are larger when the friction braking force is applied than when the regenerative braking force having the same magnitude as that of the friction braking force is applied. For this reason, when the comfort priority mode is selected, the anti-lift force and the anti-dive force acting on the vehicle 90 can be increased. Accordingly, a pitching motion of the vehicle 90 is easily suppressed.

In the braking control device 10, the fuel efficiency priority mode in which the amount of electricity generated is ensured by applying the regenerative braking force for a long time and the comfort priority mode in which a pitching motion is easily suppressed due to the braking force generated before stopping being the friction braking force can be selectively used.

Regarding the matters described in the embodiment, the pre-stop braking control executed by the process of step S108 of FIG. 3 corresponds to a first pre-stop braking control that reduces the regenerative braking force to reduce the braking force applied to the vehicle. The pre-stop braking control executed by the process of step S113 of FIG. 3 corresponds to a second pre-stop braking control that reduces the friction braking force to reduce the braking force applied to the vehicle. The fuel efficiency priority mode corresponds to a first mode in which the first replacement control and the first pre-stop braking control are executed. The comfort priority mode corresponds to a second mode in which the second replacement control and the second pre-stop braking control are executed.

The present embodiment can be changed and implemented as follows. The present embodiment and the following modification examples can be implemented in combination without technically contradicting each other.
In the embodiment, as the flow of a processing executed by the braking control device 10, an example in which in step S103 of FIG. 3, the braking force profile is set, and then in step S105, it is determined whether the fuel efficiency priority mode is selected has been provided. Instead, it may be determined whether the fuel efficiency priority mode is selected, and then the setting of the braking force profile and the setting of the determination values th1 to th3 may be performed according to the selected mode.
The process of step S105 may be omitted. Namely, when the pre-stop braking control and the replacement control are executed, the replacement control may be started after the reduction in the braking force by the pre-stop braking control is started.
In the embodiment, an example in which in step S107, the first replacement determination value exc1 is set, and then in step S108, the pre-stop braking control is started has been provided. Instead, the first replacement determination value exc1 may be set after the pre-stop braking control is started. In addition, similarly, the second replacement determination value exc2 may be set after the pre-stop braking control is started.
In the embodiment, the first replacement determination value exc1 is set to the same value as the maintenance determination value th3. The first replacement determination value exc1 may be a value smaller than the reduction determination value th2. If the first replacement determination value exc1 is a value smaller than the reduction determination value th2, the first replacement control is started after the reduction in the braking force by the pre-stop braking control is started. If the time that replacement by the first replacement control is started deviates from the time that the reduction in the braking force by the pre-stop braking control is started, compared to when the reduction in the braking force by the pre-stop braking control and replacement are started at the same time, it may be possible to shorten the period in which replacement from the regenerative braking force to the friction braking force is performed while reducing the braking force.
In the embodiment, the second replacement determination value exc2 is set to a value larger than the increase determination value th1. The second replacement determination value exc2 may be a value larger than the reduction determination value th2. If the second replacement determination value exc2 is a value larger than the reduction determination value th2, the second replacement control is started before the reduction in the braking force by the pre-stop braking control is started. If the time that replacement by the second replacement control is started deviates from the time that the reduction in the braking force by the pre-stop braking control is started, compared to when the reduction in the braking force by the pre-stop braking control and replacement are started at the same time, it may be possible to shorten the period in which replacement from the regenerative braking force to the friction braking force is performed while reducing the braking force.

Incidentally, it is preferable that a period from when replacement is started until the replacement is completed does not include a period from when the increase in the braking force by the pre-stop braking control is started until the braking force starts to be maintained at a value larger than the required braking force. Accordingly, the time that the increase in the braking force is started by braking force reduction control and the time that the replacement control is started can be made different from each other.
In the embodiment, when the predicted stopping time Ti1 becomes smaller than the required replacement time Ti2, the third replacement control is started. In the third replacement control, similarly to the first replacement control and the second replacement control, the time that replacement is started may be set based on the stopping distance DIS.
The biased distribution ratio set in step S303 of the ratio setting process illustrated in FIG. 5 may be different from the basic distribution ratio. If the distribution ratio can be adjusted such that the friction braking force applied to the front wheel or the friction braking force applied to the rear wheel is larger compared to when the friction braking force is applied according to the basic distribution ratio, the friction braking force can be applied while avoiding a braking force range in which brake squeal occurs.
The processes of steps S301 to S303 in the ratio setting process may be omitted. Namely, in the first replacement control, the friction braking force may be applied according to the basic distribution ratio.
The processes of steps S304 to S306 in the ratio setting process may be omitted. Namely, in the first replacement control, the electric parking brake device 22 may be operated.
The ratio setting process can also be omitted by omitting the process of step S110 of FIG. 3.
Even when the electric parking brake device 22 is used to calculate an EPB ratio in the ratio setting process and to apply the friction braking force, the friction braking force can also be applied via the electric parking brake device 22, first, by applying the friction braking force via operating the friction brake device 21, and next, by operating the electric parking brake device 22.
The flow of the processing of the pre-stop braking control illustrated in FIG. 4 is one example. The disclosure is not limited to the configuration in which when to start to increase the braking force is determined according to the magnitude of the stopping distance DIS. For example, when to start to increase the braking force may be determined according to vehicle speed. Even in this case, the time that the reduction in the braking force is started in the pre-stop braking control and the time that the replacement control is started may deviate from each other.
In the pre-stop braking control of the embodiment, the period in which the total braking force is increased above the required braking force is provided; however, increasing the total braking force above the required braking force is not an essential configuration. In the case where the process of increasing the total braking force above the required braking force is omitted, the reduction determination value th2 is a threshold value for starting the pre-stop braking control. In this case, the reduction determination value th2 corresponds to a pre-stop control start threshold value.

On the other hand, as in the embodiment, when the process of increasing the total braking force above the required braking force is performed, the increase determination value th1 is a threshold value for the pre-stop braking control. In this case, the increase determination value th1 corresponds to a pre-stop control start threshold value.
In the embodiment, the time that the replacement control is executed is changed depending on a mode selected by the driver of the vehicle 90. The selection of a mode can also be performed by the braking control device 10. For example, the selection unit 13 may have the function of selecting a mode. As one example, the selection unit 13 may select the fuel efficiency priority mode when the battery remaining is low. The selection of a mode is not limited to being performed by the braking control device 10, and can also be performed by other control devices.
In the embodiment, the fuel efficiency priority mode has been provided as an example of the first mode, and the comfort priority mode has been provided as an example of the second mode. The contents of the first mode and the second mode are not limited thereto. For example, when errors of a rotation angle sensor in the regenerative brake device 23 cannot be corrected, it may not be preferable that regenerative braking is continued in a state where the vehicle speed is low, such as immediately before the vehicle 90 stops. In such a case, the braking force applied to the vehicle 90 when the vehicle speed is low may be a friction braking force. Namely, as in the comfort priority mode of the embodiment, the second mode may be selected in which the second replacement control that performs replacement relatively quickly after braking is started is executed. In addition, when the temperature of the friction material is high, it may be preferable that the first mode is selected to shorten the period in which the friction braking force is applied. In addition, when the battery remaining is high, it may be preferable that the second mode is selected to suppress excessive charging via shortening the period in which the regenerative braking force is applied. As in the above configuration, the first mode or the second mode may be selected based on a state of the friction brake device 21 or the regenerative brake device 23.
The number of modes (control modes) that can be selected by the selection unit 13 may be three or more. Even in this case, it is preferable that a replacement control start threshold value is set for each control mode.
The pre-stop braking control and the replacement control in the embodiment are not limited to being executed during braking when the vehicle 90 moves forward, and can also be applied during braking when the vehicle 90 moves backward.
In the embodiment, an example in which the pre-stop braking control and the replacement control are executed has been provided; however, the execution of the pre-stop braking control is not essential. If a configuration in which the replacement control is started based on the stopping distance DIS is provided, even in a situation where the detection accuracy of vehicle speed decreases, it is possible to provide the effect that a deviation between an intended time specified in the replacement control and an actual starting time of the replacement control is unlikely to occur.

1. A braking control device that is applied to a brake device of a vehicle to adjust a regenerative braking force and a friction braking force applied to the vehicle, the breaking control device comprising:
a stopping distance acquisition unit that acquires a distance moved until the vehicle in travel stops, as a stopping distance; and
a brake adjustment unit that starts replacement control to replace the regenerative braking force among braking forces, which are applied to the vehicle, with the friction braking force when the stopping distance becomes smaller than a replacement control start threshold value.

2. The braking control device according to claim 1,
wherein when the stopping distance becomes smaller than a pre-stop control start threshold value, the brake adjustment unit starts pre-stop braking control to adjust the braking force applied to the vehicle so as to suppress a vehicle body behavior of the vehicle, and
the replacement control start threshold value is a value smaller than the pre-stop control start threshold value.

3. The braking control device according to claim 2, wherein the brake adjustment unit reduces the regenerative braking force when reducing the braking force applied to the vehicle in the pre-stop braking control.

4. The braking control device according to claim 3, further comprising:
a selection unit that selects one control mode among a plurality of control modes for the vehicle,
wherein when a first control mode is selected among the control modes by the selection unit, the brake adjustment unit starts the replacement control based on a replacement control start threshold value corresponding to the first control mode, and sets the replacement control start threshold value as a first replacement control start threshold value, and when a second control mode different from the first control mode is selected among the control modes by the selection unit, the brake adjustment unit starts the replacement control based on a second replacement control start threshold value that is a replacement control start threshold value corresponding to the second control mode and that is different from the first replacement control start threshold value.

5. The braking control device according to claim 2, further comprising:
a selection unit that selects one control mode among a plurality of control modes for the vehicle,
wherein when a first control mode is selected among the control modes by the selection unit, the brake adjustment unit starts the replacement control based on a replacement control start threshold value corresponding to the first control mode, and sets the replacement control start threshold value as a first replacement control start threshold value, and when a second control mode different from the first control mode is selected among the control modes by the selection unit, the brake adjustment unit starts the replacement control based on a second replacement control start threshold value that is a replacement control start threshold value corresponding to the second control mode and that is different from the first replacement control start threshold value.

6. The braking control device according to claim 1, further comprising:
a selection unit that selects one control mode among a plurality of control modes for the vehicle,
wherein when a first control mode is selected among the control modes by the selection unit, the brake adjustment unit starts the replacement control based on a replacement control start threshold value corresponding to the first control mode, and sets the replacement control start threshold value as a first replacement control start threshold value, and when a second control mode different from the first control mode is selected among the control modes by the selection unit, the brake adjustment unit starts the replacement control based on a second replacement control start threshold value that is a replacement control start threshold value corresponding to the second control mode and that is different from the first replacement control start threshold value.
